(19) United States
(12) Patent Application Publication
(10) Pub. No.: US 2014/0200965 A1
(43) Pub. Date: Jul. 17, 2014

(54) METHOD AND SYSTEM FOR PROVIDING A QUOTE FOR PRODUCTS FROM A CUSTOMER RELATIONSHIP MANAGEMENT SYSTEM

(71) Applicant: SALESFORCE.COM, INC., San Francisco, CA (US)

(72) Inventors: Jager McConnell, San Francisco, CA (US); Ciara Peter, San Francisco, CA (US)

(73) Assignee: salesforce.com, inc., San Francisco, CA (US)

(21) Appl. No.: 13/742,531

(22) Filed: Jan. 16, 2013

(51) Int. Cl. G06Q 30/02

(52) U.S. Cl. CPC G06Q 30/0206
USPC 705/7.35

(57) ABSTRACT

A method for providing a quote for alternative products is disclosed. The method includes identifying key features associated with a first product and identifying alternative products different from the first product based on the key features and on information managed by a CRM system. The method also includes determining an alternative product configuration associated with the first product that includes at least one alternative product and, as a whole, includes the plurality of key features. A pricing matrix associated with the alternative product configuration is generated and includes information identifying the at least one alternative product, and pricing information associated with the at least one alternative product and/or a total price associated with the alternative product configuration. A quote that includes the pricing matrix is then generated.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to an automated process for providing a quote for products from a customer relationship management system on a cloud computing platform.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Customer relationship management (CRM) refers to methodologies and strategies for helping an enterprise develop and manage customer relationships in an organized way. A CRM system typically refers to a software-based solution implemented on one or more computer devices that collect, organize and manage customer and sales information. Most CRM systems include features that allow an enterprise to track and record interactions, including emails, documents, jobs, faxes, and scheduling. These systems typically focus on accounts rather than on individual contacts. They also generally include opportunity insight for tracking sales pipelines and can include added functionality for marketing and service. For example, product catalogs can be generated that provide detailed descriptions of and pricing strategies for products, and can be used to create customer quotes on-the-fly.

Other CRM systems also offer sales force automation features that streamline all phases of the sales process. For example, such CRM systems can support tracking and recording every stage in the sales process for each prospective client, from initial contact to product selection to final disposition. In addition, CRM systems can support enterprise marketing, technical/customer support and service, event and meeting calendaring, and predictive analytics.

Typically, a CRM system can collect, store and analyze volumes of information depending on the various features supported. This information can be accessed by enterprise personnel across different groups, e.g., marketing, sales, technical support, and in some cases, by customers and external business partners. Accordingly, the CRM system can support and encourage collaboration between enterprise groups, and can help an enterprise to understand and to identify its customer needs, and to effectively build relationships between the enterprise, its customer base, and external partners.

While CRM systems are very powerful and can help an enterprise to identify an ideal product for a customer, ultimately, the customer may be unable to purchase the product, e.g., because the product is a discontinued model or is too expensive for the customer. Under these circumstances, rather than abandoning the opportunity, it would be advantageous to suggest an alternative product or a combination of alternative products that simultaneously satisfy the customer's needs and constraints. Nevertheless, identifying an alternative product or a combination of alternative products that is/are substantially equivalent to the ideal product can be difficult and time consuming when the enterprise offers numerous products, each with its features and specifications, and when new products are frequently introduced. Moreover, each product can have one or more pricing strategies, which can change dynamically whenever a new sales transaction is approved and executed. Existing CRM systems do not have the capacity to identify an alternative or a combination of alternative products that simultaneously fulfill a customer's needs and constraints.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of an exemplary method for providing a quote for products from a CRM system according to an embodiment;

FIG. 2 illustrates a representative system for providing a quote for products from a CRM system according to an embodiment;

FIG. 3 is a block diagram representing an exemplary system for providing a quote for products from a CRM system according to an embodiment;

FIG. 4 is a block diagram representing a system for providing a quote for products from a CRM system according to an embodiment;

FIG. 5A illustrates a user interface displaying a exemplary pricing matrix according to an embodiment;

FIG. 5B illustrates a user interface displaying a exemplary quote for alternative products according to another embodiment;

FIG. 6 illustrates a block diagram of an example of an environment where an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for providing a quote for products from a CRM system in a cloud computing environment. According to exemplary embodiments, a quote engine is configured to search for and retrieve product records from a CRM system that correspond to alternative products having key features of a desired product. Information relating to those alternative products can be provided to a user system of a customer or of a salesperson so that the information can be presented in real time to the customer.

According to an embodiment, the quote engine is configured to identify key features associated with a model product and to use those key features to retrieve information from the CRM system relating to alternative products. Once the information has been retrieved, the quote engine is configured to determine an alternative product configuration for the model product. The alternative product configuration includes at least one of the retrieved alternative products and, as a whole, includes the key features associated with the model product.

In addition to determining the alternative product configuration, the quote engine is configured to generate a pricing matrix for the alternative product configuration. In an embodiment, the pricing matrix can include information identifying the alternative product(s), and pricing information and/or a total price associated with the alternative product configuration. Once the pricing matrix is generated, the quote engine is configured to generate a quote that includes the pricing matrix associated with the alternative product configuration.

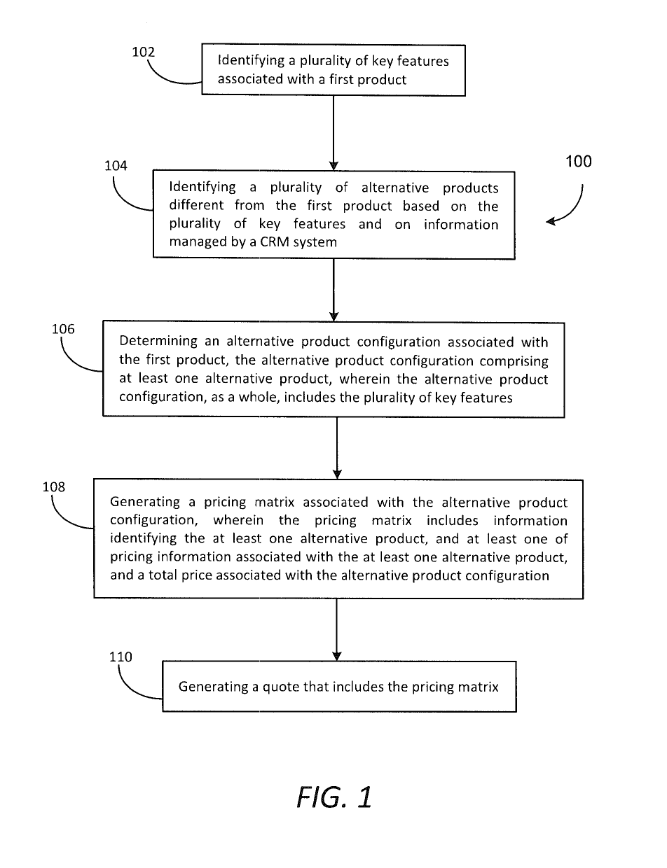

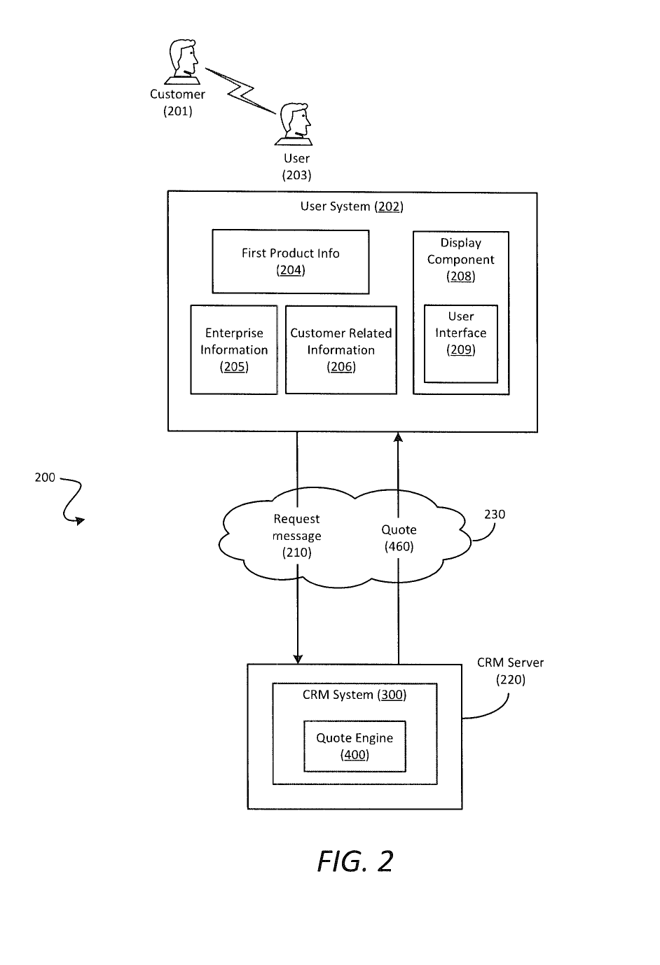

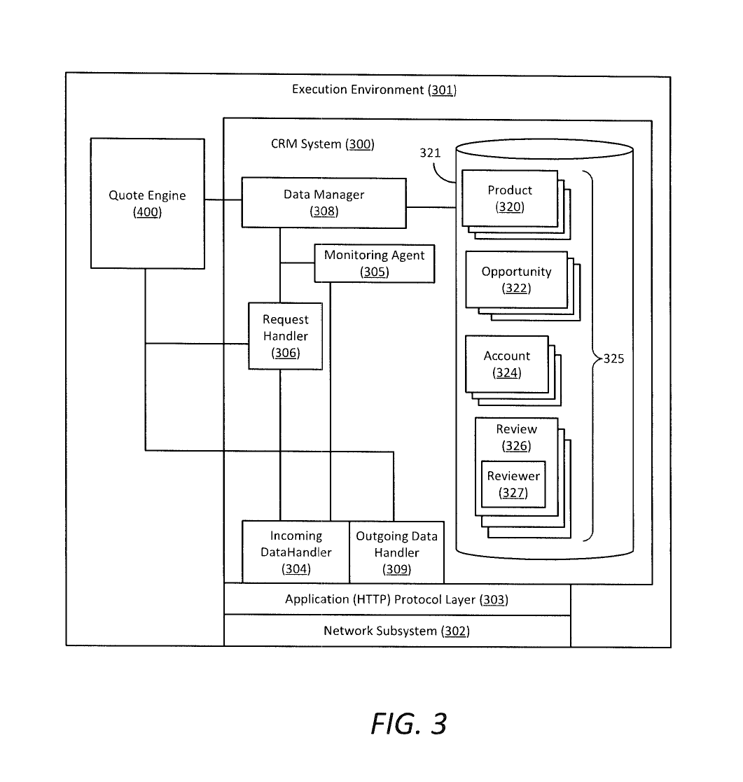

Referring now to FIG. 1, a flow diagram is presented illustrating a method 100 for providing a quote for products from a CRM system according to an embodiment. FIG. 2 illustrates a representative system 200 for providing and presenting a quote for products from a CRM system according to an embodiment. FIG. 3 is a block diagram illustrating an exemplary system for providing a quote for products from a CRM system and in particular, illustrates an arrangement of components configured to implement the method 100 of FIG. 1, which also can be carried out in environments other than that illustrated in FIG. 3.

FIG. 3 illustrates components that are configured to operate within an execution environment hosted by a physical or virtual computer node and/or multiple computer nodes, as in a distributed execution environment. Exemplary computer nodes can include physical or virtual desktop computers, servers, networking devices, notebook computers, PDAs, mobile phones, digital image capture devices, and the like. FIG. 2 illustrates a user system computer node 202 and an application server node 220 communicatively coupled to each other via a network 230, such as the Internet. In an embodiment, a CRM application server 220 can be configured to provide an execution environment configured to support the operation of the components illustrated in FIG. 3 and/or their analogs. One example of such a CRM server 220 will be described later in greater detail during reference to later illustrated embodiments.

According to an embodiment, the user system node 202 can represent a virtual or physical computer device through which a user, e.g., user 203, can communicate, via the network 230, with other users (not shown) and with application servers, such as the CRM server 220. In an embodiment illustrated in FIG. 3, a CRM system 300 includes components adapted for operating in an execution environment 301. The execution environment 301, or an analog, can be provided by a node such as the CRM server node 220. The CRM system 300 can include an incoming 304 and outgoing 309 data handler component for receiving and transmitting information from and to the user system node 202 via the network 230.

In an embodiment, the CRM system 300 includes a data store 321 for storing a plurality of data objects including a plurality of product records 320, opportunity records 322, account records 324, product/service reviews 326 and/or other records (collectively CRM records 325). As used herein, a CRM record 325 can include, but is not limited to, a tuple corresponding to a person or user, a file, a case, a folder, an opportunity, a product, an account, an event, and/or any data object. The tuple can include fields corresponding to attributes of the record. For example, a product record 320 corresponding to a product can include data relating to the product's manufacturer, its features, and its list price, while an account record 324 can include data relating to an enterprise, its location(s), and its previous product purchases and/or sales.

The CRM system 300 can include a data manager component 308 that can be configured to insert, delete, and/or update the records 325 stored in the data store 321. In addition, the CRM system 300 can include a monitoring agent 305 that is configured to monitor activities related to the CRM records 325. For example, the monitoring agent 305 can be configured to track a user's email client on the user's enterprise desktop computer, and to monitor updates to the opportunity records 322, account records 324, and/or any other CRM record(s) 325 stored in the data store 321.

In an embodiment, the data store 321 can be a database system located in a cloud computing environment, and may be implemented as a multi-tenant database system. As used herein, the term multi-tenant database system refers to those systems in which various elements of hardware and software of the database system may be shared by one or more customers. For example, a given application server 220 may simultaneously process requests for a great number of customers, and a given database table may store rows for multiple customers.

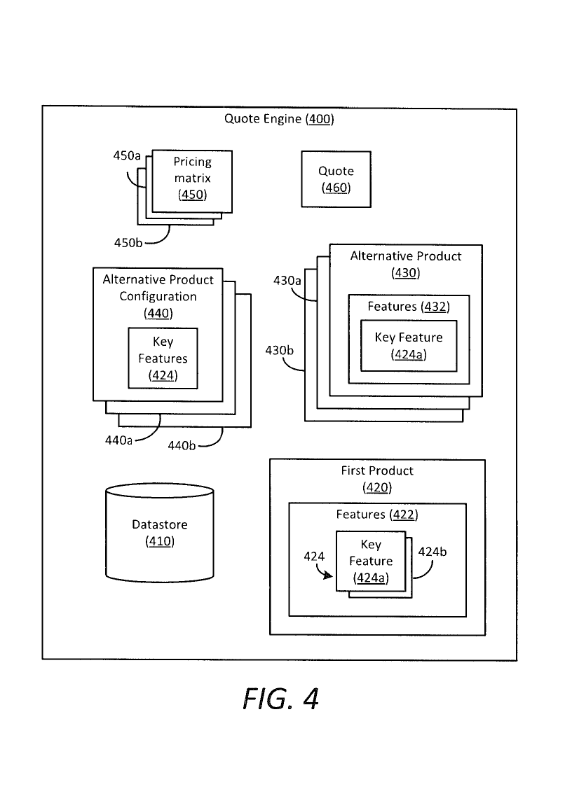

According to an embodiment, the execution environment 301, or an analog, provided by the CRM server node 220 can also include a quote engine 400. Alternatively, as is shown in FIG. 2, the quote engine 400 can be a component integrated with the CRM system 300. FIG. 4 is a block diagram illustrating an exemplary quote engine 400 according to an embodiment, which can be configured to receive information from the user system node 202, to generate a quote relating to products, and to provide the quote to the user system node 202 via the network 230. The network 230 can be a local area network (LAN) or a wide area network (WAN), such as the Internet. Each user system node 202 may include an application that allows network communication between the user system 202 and the quote engine 400 hosted by the application server 220. Such an application can be, in an embodiment, a web portal (not shown) provided by a network browser (e.g., Chrome, Internet Explorer, Safari, etc.) or the like that is capable of sending and receiving information to and from the application server 220.

FIG. 1, as stated above, illustrates a method for providing a quote for products from a CRM system. In this case, the method 100 can be implemented in the context of the CRM server 220 hosting the quote engine 400, but can also be implemented in any desired environment. According to an embodiment, the quote engine 400 can be configured to receive a message 210 from the user system 202 that includes information identifying a first product that a customer 201 wants, but for some reason cannot have, and a request for a quote corresponding to an alternative, but substantially equivalent, product. In an embodiment, the request message 210 can also include information identifying the customer 201 and/or an enterprise affiliated with the customer.

According to an embodiment, the information identifying the first product 204 can comprise a product name, a model number, and/or a list price, and the information identifying the customer 206 can include a name, title, and/or any other identifying information. The enterprise information 205 can comprise, in an embodiment, information identifying the enterprise, a product name, a brand, information identifying an industry, and/or information identifying at least one competitor enterprise. At least a portion of the identifying information 204-206 can be, in an embodiment, information stored on the user system 202, e.g., as configuration data or a default setting. Alternatively or in addition, at least a portion of the identifying information 204-206 can be provided by the user 203 via an input form or some other input document.

According to an embodiment, the quote engine 400 is configured to receive the message 210 from the user system 202 over the network 230 via a network subsystem 302 and an application protocol layer, or other higher protocol layer, as illustrated by an exemplary HTTP protocol layer 303, among many possible standard and proprietary protocol layers. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP). A request handler component 306 in the CRM system 300 can be configured to receive the message 210 via the incoming data handler 304 and to route the message to the quote engine 400 for further processing.

Referring now to FIG. 1, the process of providing a quote begins in block 102 by identifying a plurality of key features associated with the first product. According to an embodiment, the first product 420 is one that the customer wants, but for some reason cannot have. Each product, including the first product 420, includes a plurality of features 422. For example, when the first product 420 is a laptop computer, its features 422 can be directed to its color, size, weight, battery life, processor, operating system, memory and/or hard drive. In an embodiment, the quote engine 400 can be configured to automatically identify the first product's key features 422a in various ways.

For example, when the information identifying the first product 204 is received, the quote engine 400 can retrieve product records 320 corresponding to the first product 420 and corresponding to other similar products from the CRM system 300. Each product record 320 can include information identifying features 422 of the corresponding product and versioning information. According to an embodiment, the quote engine 400 can automatically identify key features 424 of the first product 420 by comparing the first product 420 to a most recent older version of the first product, and identifying key features 424 as those that are new, updated and/or different from those of the older version.

Alternatively or in addition, in an embodiment, the quote engine 400 can be configured to automatically identify the first product's key features 424 by ranking the features 422 by importance, and then selecting the key features 424 from the highest ranked features. In an embodiment, the ranking can be based on the information identifying the customer 201 and/or the information identifying the enterprise. For example, the quote engine 400 can use the customer 206 and/or the enterprise 205 information to retrieve records 325 from the CRM system 300 relating to the customer 201 and/or enterprise, and can analyze those records 325 to determine the customer's and/or enterprise's preferences, which are then used to determine which features 422 are most important. In addition, the quote engine 400 can utilize general industry preferences and/or practices to determine which features 422 are most important. Once the features 422 are ranked, the quote engine 400 can be configured to select a predetermined number of features, e.g., the top five (5) features, to be the key features 424. In an embodiment, the predetermined number can be a default value or a value defined by the customer 201 and/or the user 203.

In another embodiment, the customer 201 and/or user 203 can select the key features 424 of the first product 420 and transmit them in a message to the quote engine 400. For example, when the message 210 including the request for the quote is received and the features 422 of the first product 420 are identified, e.g., from the product record 320 corresponding to the first product 420, the quote engine 400 can generate a form that includes the features 422 and transmit the form to the user system 202 so that the customer 201 and/or the user 203 can specify which of the features 422 are the key features 424. In an embodiment, when the key features 424 have been specified, the form can be returned to the quote engine 400, which can be configured to receive the form specifying the key features 424.

Referring again to FIG. 1, once the key features 424 are identified, a plurality of alternative products different from the first product 420 are identified based on the plurality of key features 424 and on information managed by the CRM system 300 in block 104. In an embodiment, the quote engine 400 can be configured to generate at least one search query for product records 320 relating to the key features 424 and to submit the search queries to the data manager component 308 in the CRM system 300. The data manager 308 can be configured to retrieve and return product records 320 satisfying the one or more search queries.

For example, when the first product 420 is a multifunction printer and a key feature 424 is color printing, the quote engine 400 can be configured to generate a search query for alternative products 430 that support color printing, and the data manager component 308 can be configured to retrieve from the data store 321 product records 320 corresponding to alternative products 430 that satisfy the query. According to an embodiment, an alternative product 430 includes features 432, at least one of which matches a key feature 424 of the first product 420. The quote engine 400 can, in an embodiment, generate a search query for each of the plurality of key features 424, receive a result set for each query, and then merge the result sets to create a final result set that identifies the alternative products 430 that include at least one of the key features 424. For example, in an embodiment, when the first product 420 has a first 424a and a second 424b key feature, a first alternative product 430 can include the first key feature 424a but not the second key feature 424b; while a second alternative product 430a can include the second key feature 424b, but not the first key feature 424a; and a third alternative product 430b can include both the first 424a and second 424b key features.

Referring again to FIG. 1, once the plurality of alternative products 430 is identified, an alternative product configuration associated with the first product 420 is determined in block 106. According to an embodiment, the alternative product configuration 440 comprises at least one alternative product 430, and as a whole, includes each of the first product's key features 424. Thus, referring again to the previous example where the first product 420 includes first 424a and second 424b key features, the first 430 and second 430a alternative products are included in a first alternative product configuration 440, and the third alternative product 430b is included in a second alternative product configuration 440a.

As stated above, in an embodiment, the quote engine 400 can be configured to generate a search query for each key feature 424, and to receive a result set corresponding to each search query. A result set corresponding to query for a key feature 424 comprises at least one alternative product 430 that includes the key feature 424. The quote engine 400 can then determine an alternative product configuration 440 by selecting, in an embodiment, an alternative product 430 from each result set corresponding to each key feature 424.

In addition or alternatively, as stated above, an alternative product 430 can include features 432 that are not key features 424, and, in an embodiment, the quote engine 400 can be configured to examine the non-key features 432 of an alternative product 430 to determine whether they can be used to satisfy a key feature 424. For example, when the first product 420 is a network attached storage appliance that includes a key feature 424a of 32TB in capacity, and a first alternative product 430 includes a non-key feature 432 of 16TB in capacity, the quote engine 400 can be configured to determine an alternative product configuration 440 that includes two (2) of the first alternative products 430 such that the overall capacity of the alternative product configuration 440 satisfies the 32TB feature 424a.

According to an embodiment, the quote engine 400 can be configured to determine more than one alternative product configuration 440-440b associated with the first product 420. Once determined, the alternative product configuration(s) 440-440b for the first product 420 can be stored in a data store 410 associated with the quote engine 400. In this embodiment, when another message including information identifying another product and a request for a quote corresponding to an alternative product configuration is received, the quote engine 400 can determine whether the product identified in the message is the first product 420. When such is not the case, i.e., when the product identified in the message is a second product and not the first product 420, the quote engine 400 can identify alternative products 430, determine alternative product configuration(s) for the second product, and store those configuration(s) in the data store 410. Otherwise, i.e., when the product identified in the message is the first product 420, the quote engine 400 can retrieve the stored alternative product configuration(s) 440-440b from the data store 410 instead of, or in addition to, identifying the alternative products 430 and determining the alternative product configuration(s) 440 anew.

Referring again to FIG. 1, in block 108, a pricing matrix associated with the alternative product configuration 440 is generated and includes information identifying the at least one alternative product 430, and a total price associated with the alternative product configuration 440. In addition, the pricing matrix 450 can include pricing information associated with the at least one alternative product 430. In an embodiment, the pricing information can include a list price, and in some circumstances, a promotional sales price.

As stated above, each alternative product 430 is associated with a product record 320 that can include data relating to the product's manufacturer, its features, and its list price. Thus, in an embodiment, when an alternative product configuration 440 is generated, the quote engine 400 can be configured to identify the list price for each of the alternative products 430 in the product configuration 440 from the product records 320 corresponding to the alternative products 430. In addition, for each alternative product 430, the quote engine 400 can be configured, in an embodiment, to determine a promotional sales price of that product 430 based on a quantity purchased, an attribute of the customer 201, a geo-location associated with the customer 201 or enterprise, and/or a previous transaction.

For example, a sales price for an alternative product 430 can be based on purchasing a number of units that exceeds a minimum number, such that the unit cost effectively is below the product's list price. Alternatively or in addition, the sales price for a product 430 can be lower than the list price for a loyal and longtime customer 201, or for a customer or enterprise located in a certain region of the world. In addition, the sales price for a product 430 can be modified from the list price to match a price offered to the customer 201 or another customer in another transaction involving the product 430. According to an embodiment, the quote engine 400 can be configured to retrieve from the CRM system 300 data records 325, such as opportunity records 322 and/or account records 324, relating to each of the alternative products 430 to determine the sales pricing information of that product 430. Once the sales pricing information is determined, the quote engine 400 can be configured to calculate a total price associated with the alternative product configuration 440.

According to an embodiment, when more than one alternative product configuration 440, 440a, 440b is determined, the quote engine 400 can be configured to generate corresponding pricing matrices 450, 450a, 450b for each product configuration 440, 440a, 440b. In an embodiment, the pricing matrices 450, 450a, 450b can be included in a message and transmitted to the user system 202 associated with the user 203 and/or customer 201. For example, the quote engine 400 can be configured, in an embodiment, to build the message including the pricing matrices 450, 450a, 450b, and to provide the message to the outgoing data handler 309 in the CRM system 300. In an embodiment, the outgoing data handler 309 can be configured to interoperate directly with the protocol layer of the network subsystem 302 or with the application protocol layer 303. The message can be transmitted as a whole or in parts via the network subsystem 302 over the network 230 to the user system 202 associated with the user 203 and/or customer 201.

In an embodiment, the user system 202 can include a display component 208 configured for displaying content to the user 203 on a user interface 209. According to an embodiment, the user system 202 can be configured to receive the message including the pricing matrices 450, 450a, 450b, and can be configured to provide the information to the display component 208, which can be configured to render the information for display on the user interface 209. The display component 208 can be configured to render the information in a number of formats suiting the information and/or the type of user system 202.

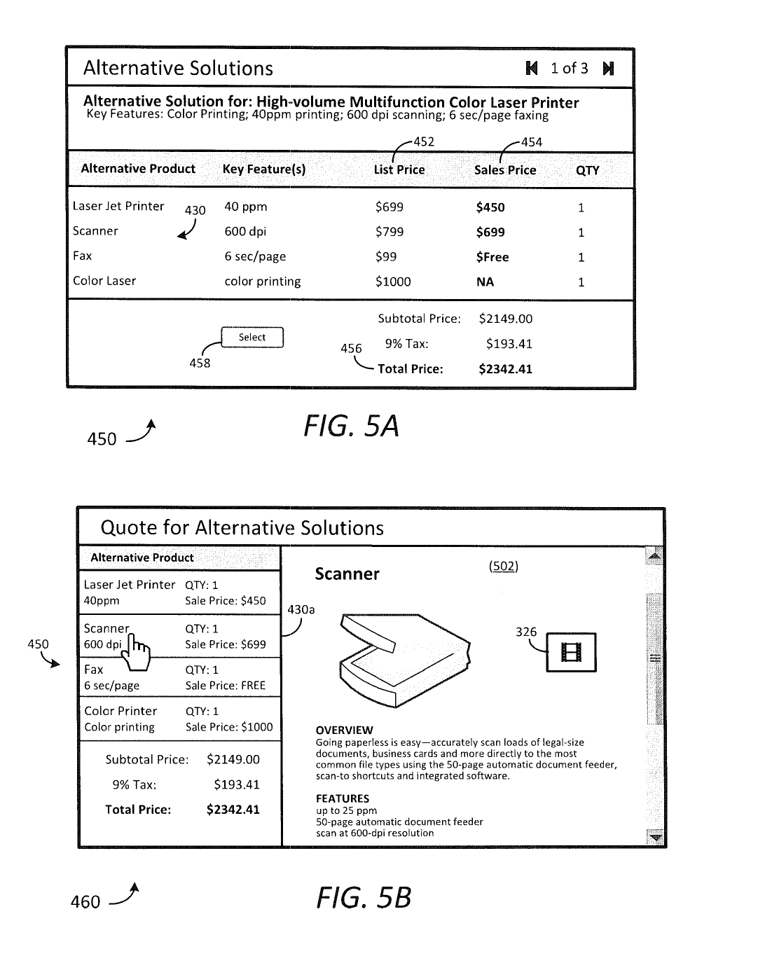

For example, in FIG. 5A, the user system 202 can be a tablet or laptop computer and the display component 208 can present on the user interface 209 a first 450 of three pricing matrices 450, 450a, 450b corresponding to a first 440 of three alternative product configurations 440, 440a, 440b. According to an embodiment, when the user 203 wishes to view a different pricing matrix 450a, 450b, the user 203 can select a “next” or “previous” matrix. As is shown, information identifying each of alternative products 430 can be displayed along with the key feature(s) each product includes, its list price 452, and its sales price 454. In addition, the total price 456 associated with the alternative product configuration 440 can be displayed.

Referring again to FIG. 1, once the pricing matrix 450 associated with the alternative product configuration 440 is generated, the quote engine 400 can be configured to generate a quote that includes the pricing matrix 450 in block 110. According to an embodiment, a quote 460 can be generated for each of a plurality of pricing matrices 450, 450a, 450b. Alternatively or in addition, the plurality of pricing matrices 450, 450a, 450b can be included in a single quote 460. In another embodiment, the quote engine 400 can be configured to generate a quote for one of the pricing matrices 450, 450a, 450b based on a preference of the user 203 and/or customer 201.

For example, in an embodiment, the user 201 or customer 203 can provide an indication including a maximum price. Such an indication can be explicitly included in the request message 210. Alternatively, the indication including the maximum price can be implicitly determined from the information identifying the first product 204, which can include the list price of the first product 420. In this embodiment, when an indication including the maximum price is received, the quote engine 400 can be configured to compare the maximum price to the total price 456 of each alternative product configuration 440, 440a, 440b to determine which, if any, of the pricing matrices 450, 450a, 450b to include in the quote(s) 460. For example, when the quote engine 400 determines that the total price 456 associated with the first alternative product configuration 440 is greater than the maximum price, and also determines that the total price 456 associated with the second alternative product configuration 440a is at most equal to the maximum price, a quote 460 that includes the second pricing matrix 450a for the second alternative product configuration 440a is generated.

Alternatively or in addition, in an embodiment where the pricing matrices 450, 450a, 450b are provided and displayed to the user 203 and/or customer 201, an indication selecting a first pricing matrix 450 can be received by the quote engine 400. For example, when the user 203 or customer 201 has viewed the pricing matrices 450, 450a, 450b and is ready to choose a first alternative product configuration 440, the user 203 can provide an indication selecting the first pricing matrix 450 associated with the first alternative product configuration 440 by selecting a button 458 displayed on the user interface 209 associated with the first pricing matrix 450. When the selection is received, the quote engine 400 can be configured to generate a quote 460 including the first pricing matrix 450.

According to an embodiment, the quote 460 can also include a recommended product review for each of the alternative products 430 in the alternative product configuration 440. In an embodiment, customer reviews 326 are created for products 320 by reviewers 327, and are stored and managed by the CRM system 300. In cases when several reviews 326 are created for a product 320, a recommended review 326 can be one that is relevant to the customer 201 and/or to the customer's enterprise. In an embodiment, the recommended review 326 can be one where the reviewer 327 is relevant to the customer 201 and/or to the customer's enterprise. For example, when the reviewer 327 is a well-respected expert in the enterprise's industry or is a close friend of the customer 201, the review 326 for the product 320 created by the reviewer 327 can be considered relevant, and retrieved from the CRM system 300. Many other factors can determine which reviews 326 are recommended, and therefore retrieved. According to an embodiment, such recommended reviews 326 can be provided by a service discussed in commonly assigned U.S. patent application Ser. No. 13/632,476, titled METHOD AND SYSTEM FOR PROVIDING A REVIEW FROM A CUSTOMER RELATIONSHIP MANAGEMENT SYSTEM, by Jager McConnell et al., filed Oct. 1, 2012, which is hereby incorporated by reference in its entirety and for all purposes. The quote engine 400 can be configured to retrieve the recommended review(s) 326 for the alternative product (s) 430 and to include them in the quote 460.

According to an embodiment, once the quote 460 is generated, a message including the quote 460 can be transmitted to the user system 202. As described above, the display component 208 in the user system 202 can be configured to receive the quote 460 and to render the information for display on the user interface 209. In FIG. 5B, an exemplary quote 460 is presented on the user interface 209 and includes the pricing matrix 450. According to an embodiment, when an alternative product, e.g., 430a, is selected, information 502 relating to the selected product 430a can be displayed. According to an embodiment, the recommended review 326 of the selected product 430a can also be provided along with the information relating to the selected product 502.

According to aspects of the exemplary embodiments, an alternative or a combination of alternative products that is/are substantially equivalent to a first product can be identified with little or no input from the customer 201 and/or the user 203. In an embodiment, key features of the first product can be identified and used by the quote engine 400 to identify a plurality of alternative products 430 based on the key features and on information managed by a CRM system 300. Once the alternative products 430 have been identified, the quote engine 400 can determine an alternative product configuration for the first product that includes at least one of the retrieved alternative products and, as a whole, includes the key features associated with the first product. A pricing matrix can be generated for the alternative product configuration and included in a quote, which can be provided to the customer 201.

### System Overview

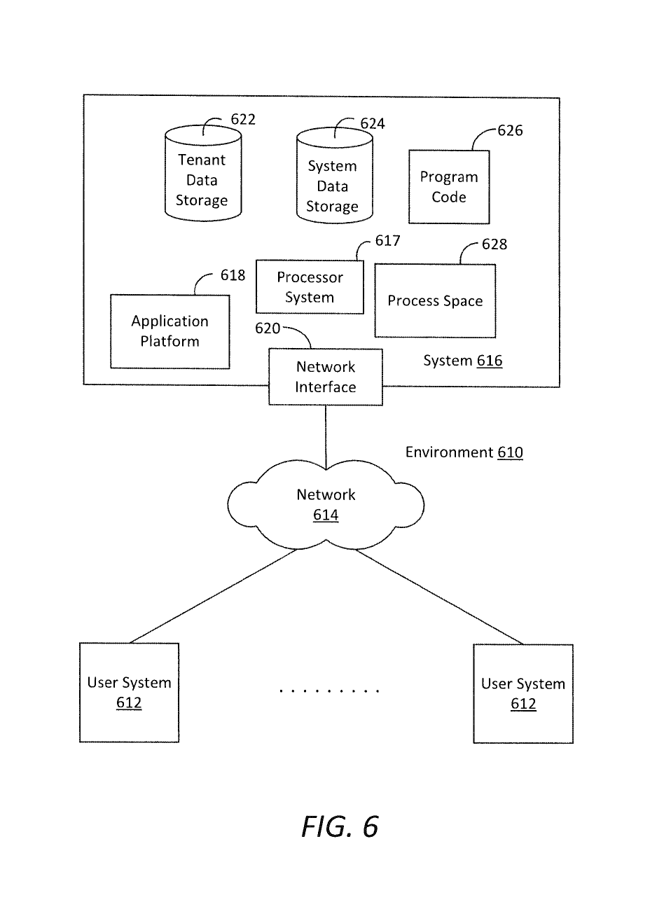

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

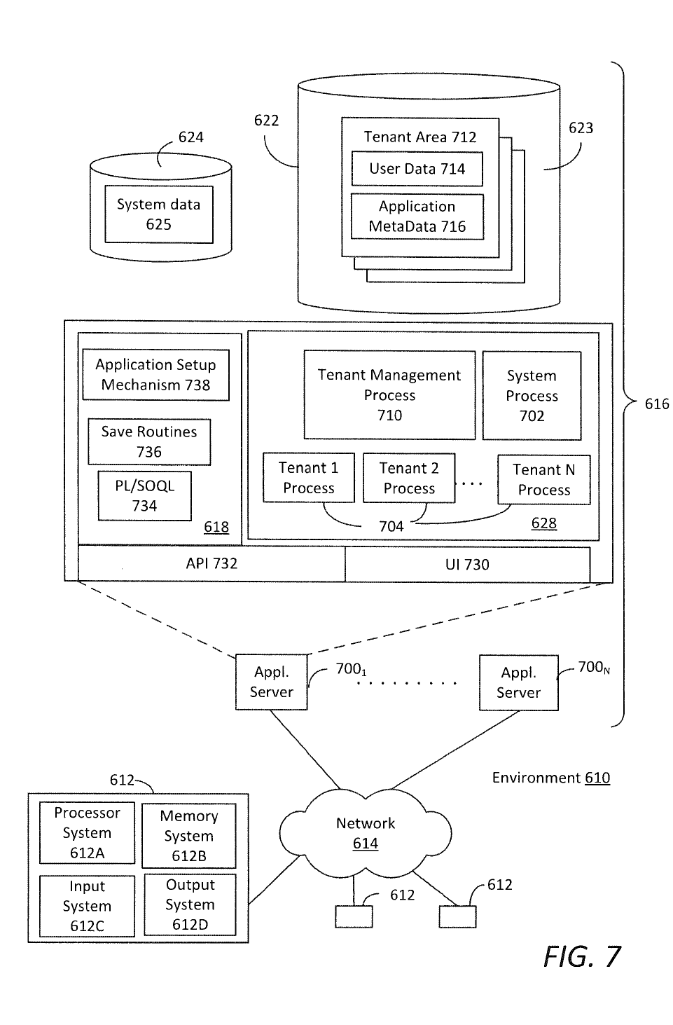

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user data storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700₁-700_{N}, an application platform 618, tenant data storage 622, and system data storage 624. Also shown is system process space 702, including individual tenant process spaces 704 and a tenant management process space 710. Each application server 700₁-700_{N} may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user data storage 714 and application metadata 716 might be similarly allocated for each user. For example, a copy of a user's most recently used (MRU) items might be stored to user data storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data 623 and the system data 625 may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by one or more system processes, which manages retrieving application metadata 716 for the subscriber making the invocation and executing the metadata as an application in a virtual machine.

Each application server 700₁-700_{N} may be communicably coupled to database systems, e.g., having access to system data 625 and tenant data 623, via a different network connection. For example, one application server 700₁ might be coupled via the network 614 (e.g., the Internet), another application server 700_{N4} might be coupled via a direct network link, and another application server 700_{N} might be coupled by yet a different network connection. Transfer Control Protocol and Internet Protocol (TCP/IP) are typical protocols for communicating between application servers 700₁-700_{N} and the database system. However, it will be apparent to one skilled in the art that other transport protocols may be used to optimize the system depending on the network interconnect used.

In certain embodiments, each application server 700₁-700_{N} is configured to handle requests for any user associated with any organization that is a tenant. Because it is desirable to be able to add and remove application servers from the server pool at any time for any reason, there is preferably no server affinity for a user and/or organization to a specific application server 700₁-700_{N}. In one embodiment, therefore, an interface system implementing a load balancing function (e.g., an F5 Big-IP load balancer) is communicably coupled between the application servers 700₁-700_{N} and the user systems 612 to distribute requests to the application servers 700₁-700_{N}. In one embodiment, the load balancer uses a least connections algorithm to route user requests to the application servers 700₁-700_{N}. Other examples of load balancing algorithms, such as round robin and observed response time, also can be used. For example, in certain embodiments, three consecutive requests from the same user could hit three different application servers 700₁-700_{N}, and three requests from different users could hit the same application server 700₁-700_{N}. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700₁-700_{N} to request and update system-level and tenant-level data from system 616 that may require sending one or more queries to tenant data storage 622 and/or system data storage 624. System 616 (e.g., an application server 700₁ in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations and techniques have been described with reference to an embodiment in which techniques for providing machine status information in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer implemented method for providing a quote for products, the method comprising:
identifying a plurality of key features associated with a first product;
identifying a plurality of alternative products different from the first product based on the plurality of key features and on information managed by a customer relationship management (CRM) system;
determining an alternative product configuration associated with the first product, the alternative product configuration comprising at least one alternative product, wherein the alternative product configuration, as a whole, includes the plurality of key features;
generating a pricing matrix associated with the alternative product configuration, wherein the pricing matrix includes information identifying the at least one alternative product, and at least one of pricing information associated with the at least one alternative product, and a total price associated with the alternative product configuration; and
generating a quote that includes the pricing matrix.

2. The method of claim 1 wherein identifying the key features of the first product includes automatically comparing features of the first product to features of a most recent older version of the first product, and identifying at least one of a new, updated and a different feature of the first product.

3. The method of claim 1 wherein identifying the key features of the first product includes receiving from a user system an indication specifying the key features.

4. The method of claim 1 further comprising receiving from a requesting user system associated with a first user a message including information identifying the first product and at least one of a customer and an enterprise, and a request for a quote corresponding to an alternative product configuration, and transmitting the quote including the pricing matrix associated with the alternative product configuration to the requesting user system.

5. The method of claim 4 wherein receiving the message from the requesting user system comprises receiving the message over a network, wherein the network is at least one of a public and a private network, and wherein the CRM system includes a multi-tenant on-demand database system.

6. The method of claim 4 wherein the first product includes a plurality of features and wherein identifying the plurality of key features comprises:
ranking, by importance, each of the plurality of features based on at least one of the information identifying the customer and the information identifying the enterprise; and
selecting the plurality of key features from the plurality of features based on the ranking.

7. The method of claim 1 wherein the alternative product configuration associated with the first product comprises a first alternative product that includes a first key feature and a second alternative product that includes a second key feature.

8. The method of claim 1 further comprising storing the alternative product configuration associated with the first product in a data store.

9. The method of claim 6 further comprising:
receiving a message including information identifying a target product and a request for a quote corresponding to an alternative product configuration for the target product;
retrieving the stored alternative product configuration associated with the first product from the data store when the target product is the first product;
determining a second alternative product configuration associated with the target product when the target product is different from the first product; and
storing the second alternative product configuration in the data store.

10. The method of claim 1 wherein the alternative product configuration is a first alternative product configuration and the method further comprises:
determining at least one other alternative product configuration associated with the first product; and
generating at least one other pricing matrix for each of the at least one other alternative product configurations.

11. The method of claim 10 wherein the pricing matrix is a first pricing matrix and the method further comprises:
providing the first pricing matrix and the at least one other pricing matrix to a user system associated with a first user;
receiving an indication selecting the first pricing matrix;
generating a quote that includes the first pricing matrix; and
transmitting the quote to the user system associated with the first user.

12. The method of claim 10 wherein the pricing matrix is a first pricing matrix and the method further comprises:
receiving an indication including a maximum price;
determining that the total price associated with the first alternative product configuration is greater than the maximum price;
determining that a total price associated with the at least one other alternative product configuration is at most equal to the maximum price; and
generating a quote that includes the at least one other pricing matrix for the at least one other alternative product configuration.

13. The method of claim 1 wherein the pricing information associated with the at least one alternative product is based on at least one of the quantity of the at least one alternative product, an attribute of a customer, a geo-location associated with the customer, and a previous transaction including the at least one alternative product.

14. The method of claim 1 wherein generating the quote includes retrieving a recommended review for the at least one alternative product, and including the recommended review for the at least one alternative product in the quote.

15. A system for providing recommended products to a user system from a customer relationship management system, the system comprising:
a processor; and
memory having instructions stored thereon, the instructions, when executed by the processor, cause the processor to perform operations comprising:
identifying a plurality of key features associated with a first product;
identifying a plurality of alternative products different from the first product based on the plurality of key features and on information managed by a customer relationship management (CRM) system;
determining an alternative product configuration associated with the first product, the alternative product configuration comprising at least one alternative product, wherein the alternative product configuration, as a whole, includes the plurality of key features;
generating a pricing matrix associated with the alternative product configuration, wherein the pricing matrix includes information identifying the at least one alternative product, and at least one of pricing information associated with the at least one alternative product and a total price associated with the alternative product configuration; and
generating a quote that includes the pricing matrix.

16. A non-transitory computer-readable medium carrying one or more sequences of instructions for providing a quote for products, which instructions, when executed by one or more processors, cause the one or more processors to perform operations comprising:
identifying a plurality of key features associated with a first product;
identifying a plurality of alternative products different from the first product based on the plurality of key features and on information managed by a customer relationship management (CRM) system;
determining an alternative product configuration associated with the first product, the alternative product configuration comprising at least one alternative product, wherein the alternative product configuration, as a whole, includes the plurality of key features;
generating a pricing matrix associated with the alternative product configuration, wherein the pricing matrix includes information identifying the at least one alternative product, and at least one of pricing information associated with the at least one alternative product and a total price associated with the alternative product configuration; and
generating a quote that includes the pricing matrix.

17. The computer-readable medium of claim 16 further comprising instructions which, when executed by the processor, cause the processor to perform operations comprising automatically comparing features of the first product to features of a most recent older version of the first product, and identifying at least one of a new, updated and a different feature of the first product.

18. The computer-readable medium of claim 16 further comprising instructions which, when executed by the processor, cause the processor to perform operations comprising receiving, from a requesting user system associated with a first user, a message including information identifying the first product and a request for a quote corresponding to an alternative product configuration, and transmitting the quote including the pricing matrix associated with the alternative product configuration to the requesting user system.

19. The computer-readable medium of claim 18 wherein the first product includes a plurality of features and wherein the instructions which cause the processor to identify the key features of the first product include instructions for:
ranking, by importance, each of the plurality of features based on at least one of the information identifying the customer and the information identifying the enterprise; and
selecting the plurality of key features from the plurality of features based on the ranking.

20. The computer-readable medium of claim 16 wherein the pricing information associated with the at least one alternative product is based on at least one of the quantity of the at least one alternative product, an attribute of a customer, a geo-location associated with the customer, and a previous transaction including the at least one alternative product.
